(19) United States
(12) Patent Application Publication
(10) Pub. No.: US 2009/0010488 A1
(43) Pub. Date: Jan. 8, 2009

(54) DRIVING SUPPORT APPARATUS, METHOD AND PROGRAM

(75) Inventors: Miki Matsuoka, Osaka-shi (JP); Shiro Ogata, Kyoto-shi (JP)

Correspondence Address: OSHA LIANG L.L.P., TWO HOUSTON CENTER, 909 FANNIN, SUITE 3500, HOUSTON, TX, 77010, US

(73) Assignee: OMRON CORPORATION, Kyoto (JP)

(21) Appl. No.: 12/135,236

(22) Filed: Jun. 9, 2008

(30) Foreign Application Priority Data
Jul. 4, 2007 (JP) 2007-175778

(51) Int. Cl. G06K 9/00

(52) U.S. Cl. 382/100; 340/573.1

(57) ABSTRACT

To improve a safety of a driving by a person of advanced age without imposing a burden on the driver.

An age estimation device, based on a facial image photographed by a photographing device, estimates an age of a driver. An inattentiveness detection device sets conditions of detecting an inattentiveness to be laxer in order that it becomes easier to detect the inattentiveness as the driver's age rises. In the event that the driver's age is of an advanced age group, an obstacle detection warning unit accelerates a timing of warning of an approximation to an obstacle, an other vehicle detection warning unit accelerates a timing of warning of an approximation to another vehicle, a cornering control unit, when the vehicle itself turns right, controls a cornering in such a way that the vehicle itself passes through a trajectory outside a normal one, and a left and right check warning unit gives a warning when the driver does not make a left and right check at an intersection. The invention can be applied to a driving support apparatus.

### BACKGROUND OF THE INVENTION

1. Technical Field

The present invention relates to a driving support apparatus, method and program, and particularly to a driving support apparatus, method and program arranged in such a way as to improve a safety of a driving by a person of advanced age without imposing a burden on the driver.

2. Related Art

In recent years, along with an aging of licensed drivers, a number of traffic accidents has increased in which drivers of advanced age are a party of the first part.

Causes thereof include a constriction of a visual field along with the aging, and a decrease in a driving ability due to a diminishment in a perceptive faculty, reflex nerves, an ability to move, a judgment or the like. Furthermore, the fact that a person of advanced age is more likely to drive in the same way as before without noticing a decrease in his or her driving ability is one of the causes leading to the increase in the number of accidents.

Therein, a configuration has been proposed in which, a driver age group being set in advance, a timing with which a warning given to the driver is transmitted, a volume of a warning sound, a size of a warning display, and the like are controlled in accordance with the set age group (for example, refer to JP-A-2003-317197).

However, with the invention described in JP-A-2003-317197, it is necessary to set the driver age group in advance, involving a time and effort. Also, in the event that an actual age of the driver and setting details do not match due to forgetting the setting, or not carrying out an update of the setting, it is not possible to give an appropriate warning to the driver.

### SUMMARY OF THE INVENTION

The invention, having been contrived bearing this kind of circumstance in mind, is designed to improve a safety of a driving by a person of advanced age without imposing a burden on the driver.

A driving support apparatus according to an aspect of the invention includes an estimation device which, based on an image obtained by photographing a driver, estimates an age of the driver, and a driving support system which, in accordance with the estimated age of the driver, carries out a support for the driver's driving in such a way as to compensate for a decrease in a driving ability due to the age.

In the driving support apparatus according to the aspect of the invention, the age of the driver is estimated based on the image obtained by photographing the driver and, in accordance with an estimated age which is the estimated age of the driver, the support for the driver's driving is carried out in such a way as to compensate for the decrease in the driving ability due to the age.

Consequently, it is possible to improve the safety of the driving by the person of advanced age without imposing a burden on the driver.

The estimation device is configured of, for example, a CPU (Central Processing Unit). The driving support system is configured of, for example, the CPU or an ECU (Electronic Control Unit).

The driving support system being provided with an inattentiveness detection device which detects the driver's inattentiveness, it is possible to arrange in such a way that the inattentiveness detection device makes conditions of detecting the inattentiveness laxer as the estimated age rises.

By this means, it is possible to more reliably prevent an accident due to an inattentiveness of the person of advanced age.

The inattentiveness detection device is configured of, for example, the CPU or the ECU.

The driving support system being provided with a warning unit which warns the driver of a danger, it is possible to arrange in such a way that the warning unit accelerates a timing of giving the warning as the estimated age rises.

By this means, it is possible for the person of advanced age to more reliably avoid a danger.

The warning unit is configured of, for example, the CPU or the ECU.

It is possible to arrange in such a way that the warning unit warns of an approximation to an obstacle or another vehicle.

By this means, it is possible to more reliably prevent a crash or a minor collision with the obstacle or the other vehicle.

The driving support system being provided with a cornering control unit which controls a cornering of a vehicle driven by the driver, it is possible to arrange in such a way that, in the event that the estimated age is at a predetermined age or over, the cornering control unit, when the vehicle turns right, controls the cornering of the vehicle in such a way that the vehicle passes outside a normal trajectory.

By this means, it is possible to prevent an accident involving the person of advanced age at an intersection.

The cornering control unit is configured of, for example, the CPU or the ECU.

It is possible to provide the driving support system with a left and right check warning unit which, in the event that the estimated age is at the predetermined age or over, monitors whether the driver makes a left and right check at an intersection and, in the event that the driver makes no left and right check, gives a warning.

By this means, it is possible to prevent the accident involving the person of advanced age at the intersection.

The left and right check warning unit is configured of, for example, the CPU or the ECU.

A driving support method or program according to another aspect of the invention includes an estimation step which, based on an image obtained by photographing a driver, estimates an age of the driver, and a driving support step which, in accordance with an estimated age which is the estimated age of the driver, carries out a support for the driver's driving in such a way as to compensate for a decrease in a driving ability due to the age.

In the driving support method or program according to the aspect of the invention, the age of the driver is estimated based on the image obtained by photographing the driver and, in accordance with the estimated age which is the estimated age of the driver, the support for the driver's driving is carried out in such a way as to compensate for the decrease in the driving ability due to the age.

Consequently, it is possible to improve the safety of the driving by the person of advanced age without imposing a burden on the driver.

The estimation step is configured of, for example, an estimation step which, based on an image obtained by photographing a driver, estimates an age of the driver by means of the CPU, and the driving support step is configured of, for example, a driving support step which, in accordance with the estimated age which is the estimated age of the driver, carries out a support for the driver's driving in such a way as to compensate for a decrease in a driving ability due to the age, by means of the CPU or the ECU.

As heretofore described, according to the aspects of the invention, it is possible to improve a safety of a driving Particularly, according to the aspects of the invention, it is possible to improve the safety of the driving by the person of advanced age without imposing a burden on the driver.

### BRIEF DESCRIPTION OF THE DRAWINGS

FIG. 1 is a block diagram showing an embodiment of a driving support apparatus to which the invention is applied;

FIG. 2 is a block diagram showing a functional configuration of an age estimation device;

FIGS. 3 and 4 are a flowchart for illustrating a driving support starting process executed by the driving support apparatus; and

FIG. 5 is a block diagram showing an example of a configuration of a personal computer.

### DESCRIPTION OF THE PREFERRED EMBODIMENT(S)

Hereafter, a description will be given of an embodiment of the invention, referring to the drawings.

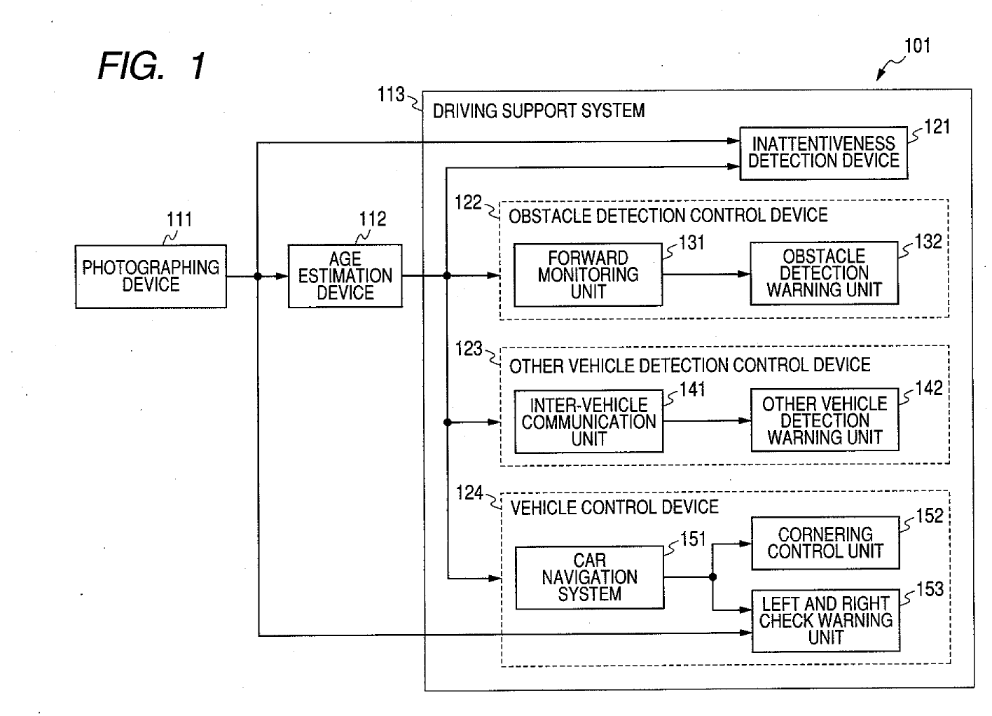

FIG. 1 is a block diagram showing an embodiment of a driving support apparatus to which the invention is applied. A driving support apparatus 101, being an apparatus which carries out a support for a driving by a driver who drives a vehicle equipped with the driving support apparatus 101 (hereafter referred to also as a vehicle itself), is configured including a photographing device 111, an age estimation device 112 and a driving support system 113.

The photographing device 111, being configured of, for example, a camera, photographs the driver's face from an approximately front direction. The photographing device 111 supplies an image including the photographed driver's face (hereafter referred to as a facial image) to the age estimation device 112, an inattentiveness detection device 121 of the driving support system 113, and a left and right check warning unit 153 of a vehicle control device 124 of the driving support system 113.

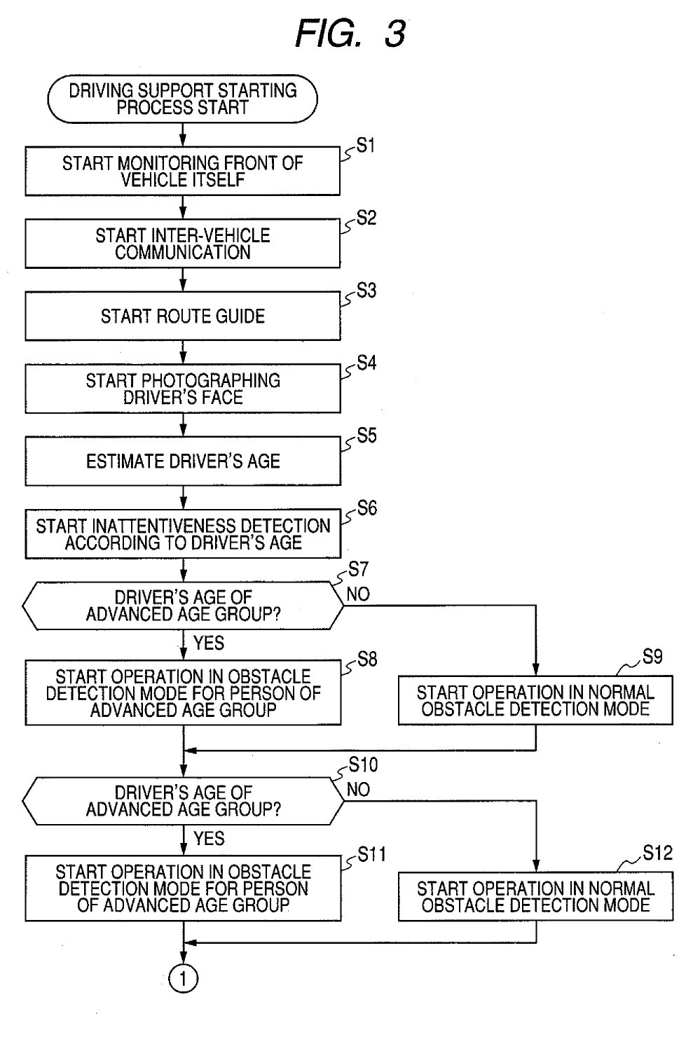

The age estimation device 112, as will be described referring to FIG. 3, estimates an age of the driver who drives the vehicle itself, and supplies information indicating a result of the estimation to the inattentiveness detection device 121, an obstacle detection control device 122, an other vehicle detection control device 123, and the vehicle control device 124, of the driving support system 113.

The driving support system 113, in accordance with the driver's age estimated by the age estimation device 112, carries out the support for the driver's driving in such a way as to compensate for a decrease in a driving ability due to the age. The driving support system 113 is configured including the inattentiveness detection device 121, the obstacle detection control device 122, the other vehicle detection control device 123 and the vehicle control device 124.

The inattentiveness detection device 121 carries out a detection of the driver's inattentiveness and, in the event that it has detected the driver's inattentiveness, warns the driver to stop an inattentive driving. The inattentiveness detection device 121 gives a warning to the driver by, for example, causing an unshown display device (for example, a monitor of a car navigation system 151) provided on the vehicle itself to display a warning display prompting the driver to stop the inattentive driving, or emitting a warning sound prompting the driver to stop the inattentive driving from an unshown speaker.

The obstacle detection control device 122 carries out a detection of an obstacle, such as a vehicle or a fallen object ahead, preventing the vehicle itself from moving forward and, in the event that it has detected an obstacle ahead of the vehicle itself, warns the driver of an approximation to the obstacle. The obstacle detection control device 122 is configured including a forward monitoring unit 131 and an obstacle detection warning unit 132.

The forward monitoring unit 131, being configured including a camera which photographs a front of the vehicle itself, or a radar or sensor which detects an object ahead of the vehicle itself, monitors the front of the vehicle itself, and supplies information indicating a result of the monitoring to the obstacle detection warning unit 132.

In the event that the obstacle detection warning unit 132 has detected an obstacle ahead of the vehicle itself, based on the result of the monitoring by the forward monitoring unit 131, it warns the driver of an approximation to the obstacle. The obstacle detection warning unit 132 warns the driver by, for example, causing the unshown display device (for example, the monitor of the car navigation system 151) provided on the vehicle itself to display a warning display warning of the approximation to the obstacle, or emitting a warning sound warning of the approximation to the obstacle from the unshown speaker.

The other vehicle detection control device 123 carries out a detection of another vehicle existing close to the vehicle itself and, in the event that it has detected an approximation to the other vehicle, warns the driver of the approximation to the other vehicle. The other vehicle detection control device 123 is configured including an inter-vehicle communication unit 141 and an other vehicle detection warning unit 142.

The inter-vehicle communication unit 141, carrying out inter-vehicle communication with the other vehicle existing close to the vehicle itself, receives information relating to the other vehicle which is a correspondent, information acquired by means of a camera or sensor provided on the other vehicle, or the like, and transmits information relating to the vehicle itself, information acquired by means of a camera or sensor provided on the vehicle itself, or the like. The inter-vehicle communication unit 141 supplies the information received from the other vehicle to the other vehicle detection warning unit 142.

The other vehicle detection warning unit 142, in the event that it has detected the approximation to the other vehicle based on the information from the inter-vehicle communication unit 141, warns the driver of the approximation to the other vehicle. The other vehicle detection warning unit 142 gives a warning to the driver by, for example, causing the unshown display device (for example, the monitor of the car navigation system 151) provided on the vehicle itself to display a warning display warning of the approximation to the other vehicle, or emitting a warning sound warning of the approximation to the other vehicle from the unshown speaker.

As the other vehicle detection warning unit 142 detects the approximation to the other vehicle based on the information received by means of the inter-vehicle communication, it is possible to easily detect an approximation to another vehicle in a position, such as a blind intersection, which cannot be seen, or is difficult to see, from the vehicle itself.

The vehicle control device 124 carries out a driving support when the vehicle itself passes through the intersection. The vehicle control device 124 is configured including the car navigation system 151, a cornering control unit 152 and the left and right check warning unit 153.

The car navigation system 151, being configured of, for example, a car navigation system available on the market, supplies various kinds of information processed by the car navigation system 151, such as a route to a destination, a current position, a road condition, traffic congestion information and peripheral information, to the cornering control unit 152 and the left and right check warning unit 153.

The cornering control unit 152 controls a cornering of the vehicle itself. That is, the cornering control unit 152, by controlling a steering or the like of the vehicle itself, controls a trajectory or the like when the vehicle itself goes around a curve.

The left and right check warning unit 153 monitors whether the driver makes a left and right check at the intersection and, in the event that it is detected that the driver has not made the left and right check, warns the driver to make the left and right check. The left and right check warning unit 153 gives a warning to the driver by, for example, causing the unshown display device (for example, the monitor of the car navigation system 151) provided on the vehicle itself to display a warning display prompting the driver to make the left and right check, or emitting a warning sound prompting the driver to make the left and right check from the unshown speaker.

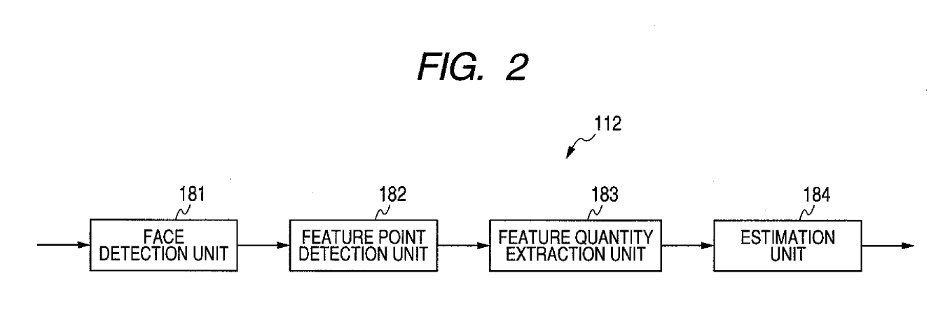

FIG. 2 is a block diagram showing a functional configuration of the age estimation device 112 of FIG. 1. The age estimation device 112 is configured including a face detection unit 181, a feature point detection unit 182, a feature quantity extraction unit 183 and an estimation unit 184.

The face detection unit 181, using a predetermined method, detects the driver's face in the facial image. The face detection unit 181 supplies the facial image, and information indicating a position of the driver's face, to the feature point detection unit 182. A method by which the face detection unit 181 detects the driver's face not being limited to a specified method, it is desirable to apply a method capable of detecting the driver's face more rapidly and accurately.

The feature point detection unit 182, using a predetermined method, detects feature points of the driver's face in the facial image. The feature point detection unit 182 detects as the feature points, for example, a mid-point between eyes, a center of a mouth, a tip of a nose, and the like, of the driver. The feature point detection unit 182 supplies the facial image, and information indicating the detected feature points, to the feature quantity extraction unit 183. A method by which the feature point detection unit 182 detects the feature points of the face not being limited to a specified method, it is desirable to apply a method capable of detecting the feature points of the face more rapidly and accurately.

The feature quantity extraction unit 183, using a predetermined method, extracts a feature quantity of the driver's face in the facial image. For example, the feature quantity extraction unit 183, using a retinal sampling method, sets sampling positions, from which the feature quantity is extracted, in such a way that the closer to the feature points of the driver s face, the more dense they are, and the farther therefrom, the sparser they are and, by applying the Gabor wavelet transform (GWT) with the feature points as a reference, extracts a periodicity and directionality of image shading in each sampling position as the feature quantity. The feature quantity extraction unit 183 supplies information indicating the extracted feature quantity to the estimation unit 184. A method by which the feature quantity extraction unit 183 extracts the feature quantity not being limited to a specified method, it is desirable to apply a method capable of extracting the feature quantity more rapidly and accurately.

The estimation unit 184, using a predetermined method, estimates the driver's age. The estimation unit 184 uses, for example, a support vector machine (SVM) to, based on the feature quantity extracted by the feature quantity extraction unit 183, estimate which age group of a young age group (for example, 18 to 30 years old), a middle age group (for example, 31 to 64 years old) or an advanced age group (for example, 65 years old and above) the driver's age belongs to. The estimation unit 184 supplies information indicating a result of the estimation to the inattentiveness detection device 121, the obstacle detection control device 122, the other vehicle detection control device 123 and the vehicle control device 124. A method by which the estimation unit 184 estimates the driver's age not being limited to a specified method, it is desirable to apply a method capable of estimating the driver's age more rapidly and accurately.

Hereafter, a description will be given of an example of a case in which the estimation unit 184 estimates which age group of the young age group (18 to 30 years old), the middle age group (31 to 64 years old) or the advanced age group (65 years old and above) the driver's age belongs to.

Also, details of a method of estimating an age of a person based on the facial image are disclosed in, for example, “Satoshi Hosoi, et al., Sex and Age Estimation System by Gabor Wavelet Transform and Support Vector Machine, Japan, Collected Papers of 8th Image Sensing Symposium Lecture, Image Sensing Technology Research Society, July 2002, pp. 243 to 246”.

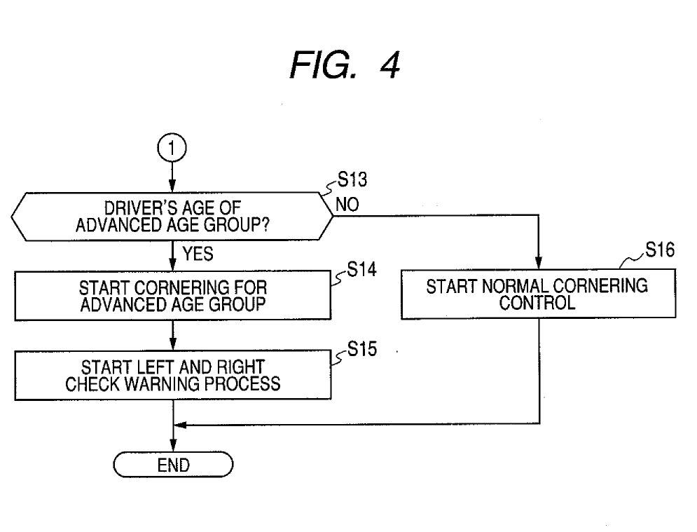

Next, a description will be given, with reference to a flowchart in FIGS. 3 and 4, of a driving support starting process executed by the driving support apparatus 101. The process is started, for example, when an engine of the vehicle itself is started up.

In step S1, the forward monitoring unit 131 starts monitoring the front of the vehicle itself. Also, the forward monitoring unit 131 starts a supply of information indicating a result of the monitoring of an existence or otherwise of an object ahead of the vehicle itself, a position of the object, a kind of the object, and the like, to the obstacle detection warning unit 132.

In step S2, the inter-vehicle communication unit 141 starts the inter-vehicle communication. Specifically, the inter-vehicle communication unit 141 carries out the inter-vehicle communication with another vehicle existing close to the vehicle itself, and starts a process of receiving the information relating to the other vehicle which is the correspondent, the information acquired from the camera or sensor provided on the other vehicle, and the like, or transmitting the information relating to the vehicle itself, the information acquired from the camera or sensor provided on the vehicle itself, and the like. The inter-vehicle communication unit 141, in the event that it has received the information from the other vehicle, supplies the received information to the other vehicle detection warning unit 142.

In step S3, the car navigation system 151 starts a route guide. Specifically, in the event that a destination has been set, the car navigation system 151, based on map data, detects a route to the destination. The car navigation system 151, on receiving an electromagnetic wave from a geodesic satellite, starts a detection of the current position of the vehicle itself, and starts the route guide in such a way as to be able to reach the destination in accordance with the detected route. Also, the car navigation system 151 starts a supply of various kinds of information processed by the car navigation system 151, such as the route to the destination, the current position, the road condition, the traffic congestion information and the peripheral information, to the cornering control unit 152 and the left and right check warning unit 153.

In step S4, the photographing device 111 starts photographing the driver's face. The photographing device 111 starts a supply of the photographed facial image to the inattentiveness detection device 121, the left and right check warning unit 153 and the face detection unit 181.

In step S5, the age estimation device 112 estimates the driver's age. Specifically, the face detection unit 181, using the predetermined method, detects the driver's face in the facial image. The face detection unit 181 supplies the facial image and the information indicating the position of the driver's face to the feature point detection unit 182.

The feature point detection unit 182, using the predetermined method, detects the feature points of the driver's face in the facial image. The feature point detection unit 182 supplies the facial image and the information indicating the detected feature points to the feature quantity extraction unit 183.

The feature quantity extraction unit 183, using the predetermined method, extracts the feature quantity of the driver's face in the facial image. The feature quantity extraction unit 183 supplies the information indicating the extracted feature quantity to the estimation unit 184.

The estimation unit 184 uses the predetermined method to, based on the feature quantity extracted by the feature quantity extraction unit 183, estimate which age group of the young age group, the middle age group or the advanced age group the driver's age belongs to. The estimation unit 184 supplies the information indicating a result of the estimation to the inattentiveness detection device 121, the obstacle detection control device 122, the other vehicle detection control device 123 and the vehicle control device 124.

In step S6, the inattentiveness detection device 121 starts a detection of an inattentiveness according to the driver's age. Specifically, the inattentiveness detection device 121 sets an angle with which to determine whether or not the driver is looking aside (hereafter referred to as an inattentiveness determination angle) in accordance with the driver's age.

In a case in which a value of a person's range of visual field is taken to be 1006 in the young age group (18 to 30 years old), it is known that a value thereof in the middle age group (31 to 64 years old) is about 60%, and a value thereof in the advanced age group (65 years old and above) is 30%. For example, the inattentiveness detection device 121, based on these values, sets the inattentiveness determination angle for a driver of the middle age group to be ⅔ of that for a driver of the young age group, and the inattentiveness determination angle for a driver of the advanced age group to be ⅓ of that for the driver of the young age group. Consequently, in the event that the inattentiveness determination angle for the driver of the young age group is 40 degrees, that is, in the event of arranging in such a way that, when a driver's face or eyes turn left or right through 40 degrees or more with respect to a front direction of the vehicle, it is determined that the driver is looking aside, the inattentiveness determination angle for the middle age group is 24 degrees, and the inattentiveness determination angle for the advanced age group is 12 degrees. That is, conditions of detecting an inattentiveness are set to be laxer in order that an inattentiveness becomes easier to detect as the driver's age rises, taking into account that the visual field becomes narrower as the age rises.

Also, the inattentiveness detection device 121 sets a time in which it is determined that the driver is looking aside (hereafter referred to as an inattentiveness determination time) to become shorter as the age rises. That is, the conditions of detecting the inattentiveness are set to be laxer in order that an inattentiveness becomes easier to detect as the driver's age rises, taking it into account that reflex nerves or a perceptive faculty decline as the age rises, and the driver needs more time to check a situation in a moving direction of the vehicle itself.

The inattentiveness detection device 121, based on the facial image supplied from the photographing device 111, starts a detection of a turning of the driver's face in a horizontal direction and, based on the set inattentiveness determination angle and inattentiveness determination time, starts a detection of the driver's inattentiveness. In the event that the inattentiveness detection device 121 has detected the inattentiveness, it warns the driver to stop the inattentive driving. At this time, for example, as the driver's age rises, the inattentiveness detection device 121 increases a volume of the warning sound, enlarges a size of letters of the warning display, changes a color of the warning display to an easily viewable color, or lengthens a warning time.

By this means, it is possible to more reliably prevent an accident due to an inattentiveness of a person of advanced age.

In step S7, the obstacle detection control device 122, based on the result of the estimation by the age estimation device 112, determines whether the driver's age is of the advanced age group. If it is determined that driver's age is of the advanced age group, the process moves to step S8.

In step S8, the obstacle detection warning unit 132 starts an operation in an obstacle detection mode for the person of advanced age. Specifically, the obstacle detection warning unit 132, based on the result of the monitoring by the forward monitoring unit 131, starts a detection of an obstacle. The obstacle detection warning unit 132, in the event that it operates in the obstacle detection mode for the person of advanced age, accelerates a timing of warning of an approximation to the obstacle in comparison with a normal obstacle detection mode, to be described hereafter. That is, the obstacle detection warning unit 132 starts the warning of the approximation to the obstacle at a time at which the obstacle exists in a position which is farther away than in the normal obstacle detection mode. Consequently, it is possible to secure a sufficient time in which the driver of the advanced age group takes an appropriate action in response to the obstacle. Also, the obstacle detection warning unit 132, for example, increases a volume of the warning sound, enlarges a size of letters of the warning display, changes a color of the warning display to an easily viewable color, or lengthens a warning time, in comparison with the normal obstacle detection mode.

By this means, it is possible for the driver of the advanced age group to reliably avoid a danger such as a crash or a minor collision with the obstacle.

Subsequently, the process moves to step S10.

In step S7, if it is determined that the driver's age is not of the advanced age group, the process moves to step S9.

In step S9, the obstacle detection warning unit 132 starts an operation in the normal obstacle detection mode. Specifically, the obstacle detection warning unit 132, based on the result of the monitoring by the forward monitoring unit 131, starts a detection of an obstacle. The obstacle detection warning unit 132, in the event that it operates in the normal obstacle detection mode, warns of an approximation to the obstacle with a normal timing, that is, with a later timing than in the obstacle detection mode for the person of advanced age. That is, the obstacle detection warning unit 132 starts a warning of the approximation to the obstacle at a time at which the obstacle has approximated a position which is closer than in the obstacle detection mode for the person of advanced age. Also, the obstacle detection warning unit 132 sets the volume of the warning sound, the size and color of the letters of the warning display, and the warning time at normal values.

In step S10, the other vehicle detection control device 123, based on the result of the estimation by the age estimation device 112, determines whether the driver's age is of the advanced age group. If it is determined that the driver's age is of the advanced age group, the process moves to step S11.

In step S11, the other vehicle detection warning unit 142 starts an operation in an other vehicle detection mode for the person of advanced age. Specifically, the other vehicle detection warning unit 142, based on the information from the inter-vehicle communication unit 141, starts a detection of another vehicle. The other vehicle detection warning unit 142, in the event that it carries out the operation in the other vehicle detection mode for the person of advanced age, accelerates a timing of warning of an approximation to the other vehicle in comparison with a normal other vehicle detection mode, to be described hereafter. That is, the other vehicle detection warning unit 142 starts the warning of the approximation to the other vehicle at a time at which the other vehicle exists in a position which is farther away than in the normal other vehicle detection mode. Consequently, it is possible to secure a sufficient time in which the driver of the advanced age group takes an appropriate action in response to the other vehicle. Also, the other vehicle detection warning unit 142, for example, increases a volume of the warning sound, enlarges letters of the warning display, changes a color of the warning display to an easily viewable color, or lengthens a warning time in composition with the normal other vehicle detection mode.

By this means, it is possible for the driver of the advanced age group to reliably avoid a danger such as a crash or a minor collision with the other vehicle.

Subsequently, the process moves to step S13.

In step S10, if it is determined that the driver's age is not of the advanced age group, the process moves to step S12.

In step S12, the other vehicle detection warning unit 142 starts an operation in the normal other vehicle detection mode. Specifically, the other vehicle detection warning unit 142, based on the information from the inter-vehicle communication unit 141, starts a detection of another vehicle. The other vehicle detection warning unit 142, in the event that it operates in the normal other vehicle detection mode, warns of an approximation to the other vehicle with a normal timing, that is, with a later timing than in the other vehicle detection mode for the person of advanced age. That is, the other vehicle detection warning unit 142 starts a warning of the approximation to the other vehicle at a time at which the other vehicle has approximated a position which is closer than in the other vehicle detection mode for the person of advanced age. Also, the other vehicle detection warning unit 142 sets the volume of the warning sound, the size and color of the letters of the warning display, and the warning time at normal values.

In step S13, the vehicle control device 124, based on the result of the estimation by the age estimation device 112, determines whether the driver's age is of the advanced age group. If it is determined that the driver's age is of the advanced age group, the process moves to step S14.

In step S14, the cornering control unit 152 carries out the cornering control for the advanced age group.

An evaluation result indicating that a driver of advanced age is more likely to take a shortcut inside a center of an intersection at a time of a right turn has been reported in “Satoshi Hosoi, et al., Ascertainment of Right Turn Time Unsafe Movements based on Daily Driving Behavior Records of People of Advanced Age, and Evaluation thereof (First Report), Japan, Collection of Academic Lecture Preprints No. 57-06, Institute of Automotive Technology Association, May 2006, pp. 5 to 10” (hereafter referred to as a cited reference 1).

Therein, subsequently, the cornering control unit 152, in the event that the vehicle itself turns right, controls the cornering in such a way that the vehicle itself passes through a trajectory outside a normal trajectory. By this means, a vehicle driven by the driver of the advanced age being prevented from taking the shortcut inside the center of the intersection at the time of the right turn, it is possible to prevent an accident at the intersection.

In step S15, the left and right check warning unit 153 starts a left and right check warning process, and finishes the driving support starting process.

An evaluation result indicating that the driver of the advanced age group is more likely to forget to check a two-way cross traffic has been reported in the heretofore described cited reference 1.

Therein, the left and right check warning unit 153, based on the facial image supplied from the photographing device 111, starts a detection of a turning of the driver's face in the horizontal direction. Also, the left and right check warning unit 153, based on the information supplied from the car navigation system 151, starts a detection of a timing with which the vehicle itself passes through the intersection. Furthermore, the left and right check warning unit 153 starts a monitoring of whether the driver is making a left and right check at the intersection. If it determines that the driver is not making the left and right check at the intersection, the left and right check warning unit 153 warns the driver to make the left and right check. In this case, it is also acceptable that the left and right check warning unit 153 displays a warning display in a direction which the driver has not checked, or emits a warning sound from a direction which the driver has not checked. By this means, the driver of the advanced aged group being prevented from forgetting to make the left and right check at the intersection, it is possible to prevent an accident at the intersection.

Meanwhile, if it is determined in step S13 that the driver's age is not of the advanced age group, the process moves to step S16.

In step S16, the cornering control unit 152 starts a normal cornering control, and finishes the driving support starting process. Specifically, the cornering control unit 152 subsequently controls the cornering in such a way as to pass through the normal trajectory at the time of the right turn.

As the driver's age is automatically estimated, and the support for the driver's driving is carried out in accordance with the estimated age in such a way as to compensate for the decrease in the driving ability due to the age, as heretofore described, it is possible to improve a safety of the driving by the person of advanced age without imposing a burden on the driver. Also, it is possible to prevent the driving support from not being appropriately carried out due to forgetting to set the age or erroneously setting the age.

Although the example of estimating the age based on the image including the driver's face has been shown in the above description, it is also acceptable to arrange in such a way as to estimate the age, for example, based on other features of the driver's body.

Also, although the example of estimating which age group of the young age group, middle age group or advanced age group the driver's age belongs to has been shown in the above description, it is also acceptable to estimate the age in more detail, and carry out a more meticulous driving support corresponding to the driver's age. It is also acceptable to arrange in such a way that, for example, by classifying the obstacle detection mode and the other vehicle detection mode more minutely, the obstacle detection warning unit 132 and the other vehicle detection warning unit 142 carry out operations corresponding to the minutely classified modes.

Furthermore, it is also acceptable to arrange in such a way as to, in accordance with the driver's age, automatically adjust a brightness, a color or the like of a display of a display device mounted on the vehicle, such as an instrumental panel or the monitor of the car navigation system, in such a way that the driver of each age group can easily see the display.

It is possible both to execute the heretofore described series of processes by means of hardware, and execute them by means of software. In a case of executing the series of processes by means of software, a program configuring the software is installed on a computer incorporated in designated hardware or, for example, a general-purpose personal computer which, by installing various programs, can execute various functions, from a program recording medium.

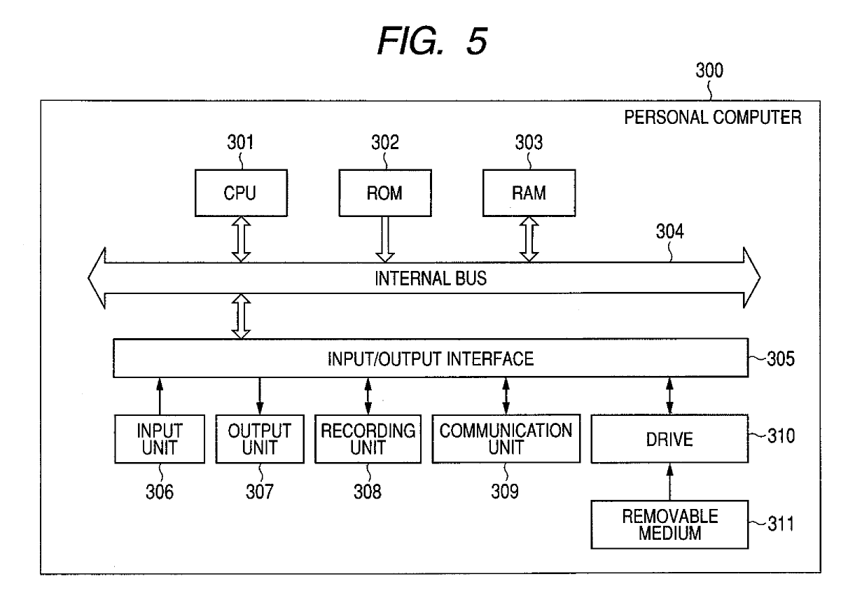

FIG. 5 is a block diagram showing an example of a configuration of a personal computer 300 which executes the heretofore described series of processes by means of a program. A CPU (Central Processing Unit) 301 executes various processes in accordance with a program stored in an ROM (Read Only Memory) 302 or a recording unit 308. A program, data and the like to be executed by the CPU 301 are stored in a RAM (Random Access Memory) 303 as appropriate. The CPU 301, the ROM 302 and the RAM 303 are mutually connected by a bus 304.

An input/output interface 305 is also connected to the CPU 301 via the bus 304. An input unit 306, configured of a keyboard, a mouse, a microphone and the like, and an output unit 307, configured of a display, a speaker and the like, are connected to the input/output interface 305. The CPU 301 executes the various processes in response to a command input from the input unit 306. Then, the CPU 301 transmits results of the processes to the output unit 307.

The recording unit 308 connected to the input/output interface 305, being configured of, for example, a hard disk, stores the program and various data to be executed by the CPU 301. A communication unit 309 communicates with an external device via a network such as an internet or a local area network.

Also, it is also acceptable to acquire a program via the communication unit 309, and store it in the recording unit 308.

A drive 310 connected to the input/output interface 305, when a removable medium 311, such as a magnetic disk, an optical disk, a magneto optical disk, or a semiconductor memory, is attached thereto, drives it and acquires a program, data or the like recorded thereon. The acquired program or data are forwarded to the recording unit 308 when needed, and stored.

The program recording medium, installed on the computer, which stores a computer executable program, is configured of a removable medium 311, which is a package medium configured of the magnetic disk (including a flexible disk), the optical disk (including a CD-ROM (Compact Disc-Read Only Memory) or a DVD (Digital Versatile Disc)), the magneto optical disk, the semiconductor memory or the like, the ROM 302, in which a program is temporarily or permanently stored, or the hard disk configuring the recording unit 308, as shown in FIG. 5. The storage of the program in the program recording medium is carried out, using a wired or wireless communication medium, such as the local area network, the internet or a digital satellite broadcasting, via the communication unit 309 which is an interface such as a router or a modem when needed.

In the present specification, a step of describing the program stored in the program recording medium includes not only processes chronologically carried out in a described order, but also processes executed in parallel or individually, although not always processed in the chronological order.

Furthermore, the embodiment of the invention not being limited to the heretofore described embodiment, various modifications are possible without departing from the scope of the invention.

What is claimed is:

1. A driving support apparatus comprising:
an estimation device which, based on an image obtained by photographing a driver, estimates an age of the driver; and
a driving support system which, in accordance with the estimated age of the driver, carries out a support for the driver's driving in such a way as to compensate for a decrease in a driving ability due to the age.

2. The driving support apparatus according to claim 1, wherein
the driving support system includes an inattentiveness detection device which detects the driver's inattentiveness, wherein
the inattentiveness detection device sets conditions of detecting the inattentiveness to become laxer as the estimated age rises.

3. The driving support apparatus according to claim 1, wherein
the driving support system includes a warning unit which warns the driver of a danger, wherein
the warning unit accelerates a timing of giving the warning as the estimated age rises.

4. The driving support apparatus according to claim 3, wherein
the warning unit warns of an approximation to an obstacle or another vehicle.

5. The driving support apparatus according to claim 1, wherein
the driving support system includes a cornering control unit which controls a cornering of a vehicle driven by the driver, wherein
in the event that the estimated age is at a predetermined age or over, the cornering control unit, when the vehicle turns right, controls the cornering of the vehicle in such a way that the vehicle passes outside a normal trajectory.

6. The driving support apparatus according to claim 1, wherein
the driving support system includes a left and right check warning unit which, in the event that the estimated age is at the predetermined age or over, monitors whether the driver makes a left and right check at an intersection and, in the event that the driver makes no left and right check, gives a warning.

7. A driving support method comprising:
an estimation step which, based on an image obtained by photographing a driver, estimates an age of the driver; and
a driving support step which, in accordance with the estimated age of the driver, carries out a support for the driver's driving in such a way as to compensate for a decrease in a driving ability due to the age.

8. A program for causing a computer to execute a process including:
an estimation step which, based on an image obtained by photographing a driver, estimates an age of the driver; and
a driving support step which, in accordance with the estimated age of the driver, carries out a support for the driver's driving in such a way as to compensate for a decrease in a driving ability due to the age.
